(19) United States
(12) Patent Application Publication
(10) Pub. No.: US 2008/0128396 A1
(43) Pub. Date: Jun. 5, 2008

(54) Laser beam machining system

(75) Inventors: Koichi Shigematsu, Ota-ku (JP); Kouichi Nehashi, Ota-ku (JP)

Correspondence Address: GREER, BURNS & CRAIN, 300 S WACKER DR, 25TH FLOOR, CHICAGO, IL, 60606, US

(73) Assignee: Disco Corporation, Tokyo (JP)

(21) Appl. No.: 11/985,353

(22) Filed: Nov. 14, 2007

(30) Foreign Application Priority Data
Nov. 17, 2006 (JP) 2006-311839

(51) Int. Cl. B23K 26/38

(52) U.S. Cl. 219/121.67

(57) ABSTRACT

A laser beam machining system includes a chuck table for holding a work, a laser beam irradiation unit for irradiating the work held on the chuck table with a laser beam, a machining feeding unit for effecting relative machining feed of the chuck table and the laser beam irradiation unit, and a control unit for controlling the laser beam irradiation unit and the machining feeding unit according to control programs, wherein a safety unit is provided which interrupts a gate signal, which is outputted from the control unit to the laser beam irradiation unit, upon generation of an abnormal condition in execution of the control programs in the control unit.

### BACKGROUND OF THE INVENTION

1. Field of the Invention

The present invention relates to a laser beam machining system for laser beam machining of a work such as a semiconductor wafer.

2. Description of the Related Art

In a semiconductor device manufacturing process, a plurality of regions are demarcated by planned split lines, called streets, which are arranged in a lattice form in a surface of a substantially circular disk-shaped semiconductor wafer, and devices such as ICs and LSIs are formed in the thus demarcated regions. Then, the semiconductor wafer is cut along the streets so as to split the regions provided with the devices from each other, thereby manufacturing individual semiconductor chips. In addition, an optical device wafer in which light receiving devices such as photo-diodes, light emitting devices such as laser diodes, and/or the like are stacked on a surface of a sapphire substrate is also cut along the streets, whereby the optical device wafer is split into individual optical devices such as photo-diodes, laser diodes, etc., which are widely used in electric apparatuses.

As a method for splitting the above-mentioned wafer, such as semiconductor wafer and optical device wafer, along the streets, there has been proposed a method in which irradiation with a laser beam is conducted along the streets formed in the wafer surface so as to form laser beam-machined grooves, and the wafer is broken along the laser beam-machined grooves (refer to, for example, Japanese Patent Laid-open No. Hei 10-305420).

When an abnormal condition is generated in a control means for controlling operating means in a laser beam machining system, the operating means may be brought into runaway (an operation out of control). For example, when an abnormal condition in a program is generated under the condition where a gate signal for irradiation with a laser beam is outputted from the control means to a laser beam irradiation means, the control means may continue outputting the gate signal for irradiation with a laser beam. As a result, the laser beam would be condinuedly radiated from the laser beam irradiation means, possibly causing a fire or the like.

### SUMMARY OF THE INVENTION

Accordingly, it is an object of the present invention to provide a laser beam machining system such that, when an abnormal condition in a control program is generated under the condition where a gate signal for irradiation with a laser beam is outputted from a control means to a laser beam irradiation means, the gate signal is interrupted, whereby the irradiation with the laser beam from the laser beam irradiation means can be stopped.

In accordance with an aspect of the present invention, there is provided a laser beam machining system including: a chuck table for holding a work; a laser beam irradiation means for irradiating the work held by the chuck table with a laser beam; a machining feeding means for relative machining feed of the chuck table and the laser beam irradiation means; a control means for controlling the laser beam irradiation means and the machining feeding means according to a control program; and a safety means for interrupting a gate signal, which is outputted from the control means to the laser beam machining means, upon generation of an abnormal condition in execution of the control program in the control means.

Preferably, the safety means includes: an interrupter which is disposed in a circuit for outputting the gate signal from the control means to the laser beam irradiation means and which interrupts the gate signal; a watchdog timer for detecting an abnormal condition in execution of the control program; and an interrupting signal output means for outputting an interrupting signal to the interrupter upon receiving a gate signal and an abnormal-condition signal outputted from the watchdog timer.

The laser beam machining system according to the present invention has the safety means for interrupting the gate signal, which is normally outputted from the control means to the laser beam irradiation means, upon generation of an abnormal condition in execution of a control program in the control means. Therefore, even if an abnormal condition in the control program is generated during when the gate signal is outputted from the control means to the laser beam irradiation means, continued irradiation with the laser beam from the laser beam irradiation means can be prevented from occurring.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser beam machining system configured according to the present invention;

FIG. 2 is a perspective view of an essential part of the laser beam machining system shown in FIG. 1; and

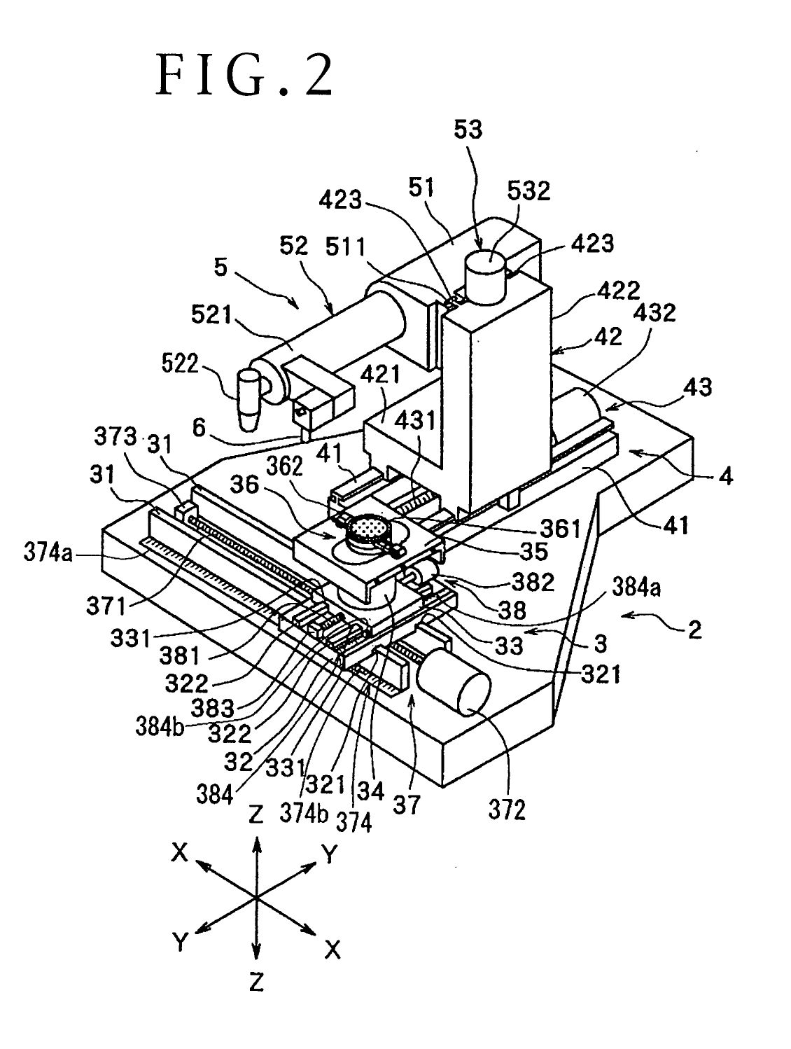

FIG. 3 is a block diagram showing a laser beam irradiation means and a control means which are provided in the laser beam machining system shown in FIG. 1.

### DETAILED DESCRIPTION OF THE PREFERRED EMBODIMENTS

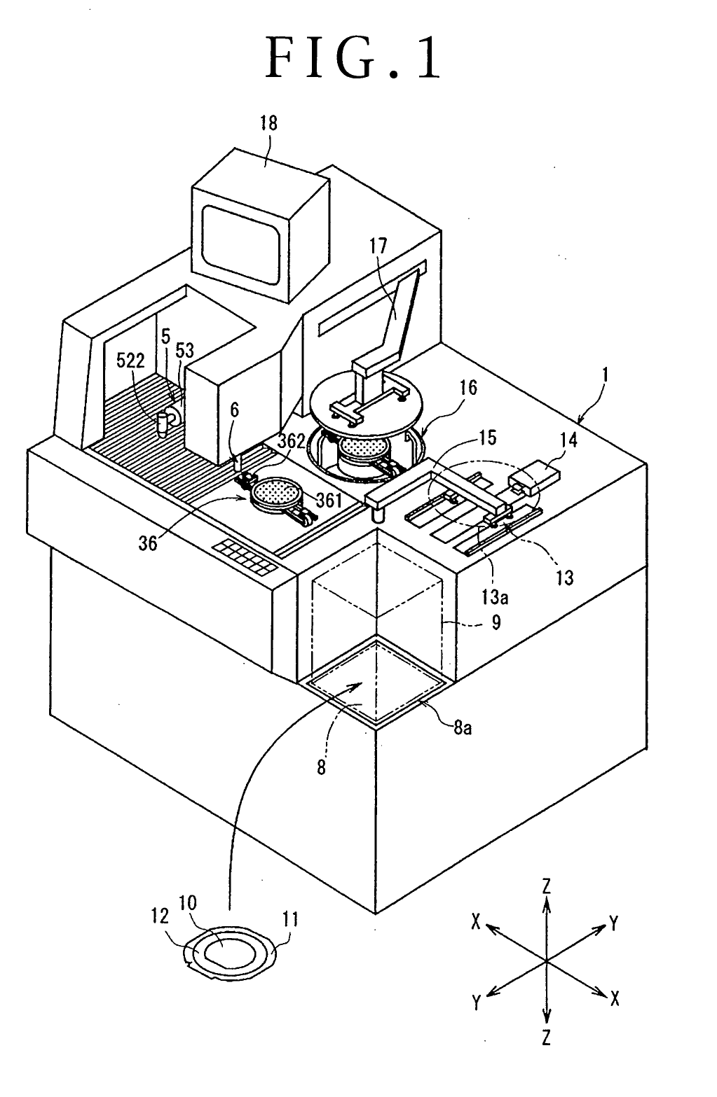

Now, a preferred embodiment of the laser beam machining system configured according to the present invention will be described in detail below, referring to the attached drawings. The laser beam machining system shown in FIG. 1 has a substantially rectangular parallelopiped system housing 1. In the system housing 1, there are disposed a stationary base 2, a chuck table mechanism 3 having a chuck table which is disposed on the stationary base 2 so as to be movable in the direction of arrow X, i.e., the machining feed direction, and which holds a work, a laser beam irradiation unit support mechanism 4 disposed on the stationary base 2 so as to be movable in the direction of arrow Y (the direction orthogonal to the direction of arrow X which is the machining feed direction), i.e., an indexing feed direction, and a laser beam irradiation unit 5 disposed in the laser beam irradiation unit support mechanism 4 so as to be movable in the direction of arrow Z, i.e., the vertical direction in the figure.

The chuck table mechanism 3 includes: a pair of guide rails 31, 31 disposed on the stationary base 2 and in parallel along the machining feed direction indicated by arrow X; a first slide block 32 disposed on the guide rails 31, 31 so as to be movable in the machining feed direction indicated by arrow X; a second slide block 33 disposed on the first slide block 32 so as to be movable in the indexing feed direction indicated by arrow Y; a support table 35 supported on the second slid block 33 by a hollow cylindrical member 34; and the chuck table 36 as a work holding means. The chuck table 36 has a suction chuck 361 formed from a porous material, and a wafer as the work is held on the suction chuck 361 by a suction means (not shown). The chuck table 36 thus configured is rotated by a pulse motor (not shown) disposed in the hollow cylindrical member 34. Incidentally, the chuck table 36 is equipped with clamps 362 for fixing an annular frame which will be described later.

The first slide block 32 is provided in its lower surface with a pair of guided grooves 321, 321 to be engaged with the pair of guided rails 31, 31, and is provided at its upper surface with a pair of guide rails 322, 322 formed in parallel along the indexing feed direction indicated by arrow Y. The first slid block 32 thus configured can be moved in the machining feed direction indicated by arrow X along the pair of guide rails 31, 31, through the engagement of its guided grooves 321, 321 with the pair of guide rails 31, 31. The chuck table mechanism 3 in the embodiment shown has a machining feeding means 37 for moving the first slide block 32 in the machining feed direction indicated by arrow X along the pair of guide rails 31, 31.

The machining feeding means 37 includes a male screw rod 371 disposed between and in parallel to the pair of guide rails 31 and 31, and a drive source such as the pulse motor 372 for rotationally driving the male screw rod 371. The male screw rod 371 is rotatably borne at its one end on a bearing block 373 fixed to the stationary base 2, and is connected at its other end to an output shaft of the pulse motor 372 on a power transmission basis. Incidentally, the male screw rod 371 is in screw engagement with a penetrating female screw hole formed in a female screw block (not shown) projectingly provided at a lower surface of a central part of the first slide block 32. Therefore, with the male screw rod 371 driven by the pulse motor 372 to rotate normally and reversely, the first slide block 32 is moved in the machining feed direction indicated by arrow X along the guide rails 31, 31.

The laser beam machining system in the embodiment shown has a machining feed quantity detecting means 374 for detecting the quantity of machining feed of the chuck table 36. The machining feed quantity detecting means 374 is composed of a linear scale 374a disposed along the guide rail 31, and a reading head 374b disposed on the first slide block 32 and moved along the linear scale 374a together with the first slide block 32. The reading head 374b of the machining feed quantity detecting means 374, in the embodiment shown, sends to a control means (described later) one pulse signal in correspondence with each 1 μm. Then, the control means (described later) counts the pulse signals inputted thereto, to thereby detect the quantity of machining feed of the chuck table 36.

Incidentally, in the case where the pulse motor 372 is used as the drive source in the machining feeding means 37, the quantity of machining feed of the chuck table 36 can be detected by counting the driving pulses outputted from the control means (described later) for outputting a driving signal to the pulse motor 372. Besides, in the case where a servo motor is used as the drive source in the machining feeding means 37, the quantity of machining feed of the chuck table 36 can be detected by sending to the control means (described later) pulse signals outputted from a rotary encoder for detection of the number of revolutions of the servo motor, and counting the inputted pulse signals by the control means.

The second slide block 33 is provided in its lower surface with a pair of guided grooves 331, 331 to be engaged with the pair of guide rails 322, 322 provided at the upper surface of the first slide block 32, and is movable in the indexing feed direction indicated by arrow Y, through the engagement of its guided grooves 331, 331 with the pair of guide rails 322, 322. The chuck table mechanism 3, in the embodiment shown, has a first indexing feeding means 38 for moving the second slide block 33 in the indexing feed direction indicated by arrow Y along the pair of guide rails 322, 322 provided on the first slide block 32. The first indexing feeding means 38 includes a male screw rod 381 disposed between and in parallel to the pair of guide rails 322 and 322, and a drive source such as a pulse motor 382 for rotationally driving the male screw rod 381. The male screw rod 381 is rotatably borne at its one end on a bearing block 382 fixed to the upper surface of the first slide block 32, and is connected at its other end to an output shaft of the pulse motor 382 on a power transmission basis. Incidentally, the male screw rod 381 is in screw engagement with a penetrating female screw hole formed in a female screw block (not shown) projectingly provided at a lower surface of a central part of the second slide block 33. Therefore, with the male screw rod 381 driven by the pulse motor 382 to rotate normally and reversely, the second slide block 33 is moved in the indexing feed direction indicated by arrow Y along the guide rails 322, 322.

The laser beam machining system, in the embodiment shown, has an indexing feed quantity detecting means 384 for detecting the quantity of indexing feed of the second slide block 33. The indexing feed quantity detecting means 384 is composed of a linear scale 384a disposed along the guide rail 322, and a reading head 384b disposed on the second slide block 33 and moved along the linear scale 384a. The reading head 384b of the indexing feed quantity detecting means 384, in the embodiment shown, sends to the control means (described later) one pulse signal in correspondence with each 1 μm. Then, the control means (described later) counts the pulse signals inputted thereto, thereby to detect the quantity of indexing feed of the laser beam irradiation unit 5.

Incidentally, in the case where the pulse motor 382 is used as a drive source in the first indexing feeding means 38, the quantity of indexing feed of the laser beam irradiation unit 5 can be detected by counting the drive pulses outputted from the control means (described later) for outputting a driving signal to the pulse motor 382. Besides, in the case where a servo motor is used as the drive source in the first indexing feeding means 38, the quantity of indexing feed of the second slide block 33, i.e., of the chuck table 36 can be detected by sending to the control means (described later) pulse signals outputted from a rotary encoder for detection of the number of revolutions of the servo motor, and counting the inputted pulse signals by the control means.

The laser beam irradiation unit support mechanism 4 includes a pair of guide rails 41, 41 disposed on the stationary base 2 and in parallel along the indexing feed direction indicated by arrow Y, and a movable support base 42 disposed on the guide rails 41, 41 so as to be movable in the direction of arrow Y. The movable support base 42 is composed of a movable support part 421 disposed movably on the guide rails 41, 41, and a mount part 422 attached to the movable support part 421. The mount part 422 is provided on its one side surface with a pair of guide rails 423, 423 which extend in the direction of arrow Z and which are parallel to each other. The laser beam irradiation unit support mechanism 4, in the embodiment shown, has a second indexing feeding means 43 for moving the movable support base 42 in the indexing feed direction indicated by arrow Y along the pair of guide rails 41, 41.

The second indexing feeding means 43 includes a male screw rod 431 disposed between and in parallel to the pair of guide rails 41, 41, and a drive source such as a pulse motor 432 for rotationally driving the male screw rod 431. The male screw rod 431 is rotatably borne at its one end on a bearing block (not shown) fixed to the stationary base 2, and is connected at its other end to an output shaft of the pulse motor 432. Incidentally, the male screw rod 431 is in screw engagement with a female screw hole formed in a female block (not shown) projectingly provided at a lower surface of a central part of a movable support part 421 constituting the movable support base 42. Therefore, with the male screw rod 431 driven by the pulse motor 432 to rotate normally and reversely, the movable support base 42 is moved in the indexing feed direction indicated by arrow Y along the guide rails 41, 41.

The laser beam irradiation unit 5, in the embodiment shown, includes a unit holder 51, and a laser beam irradiation means 52 mounted to the unit holder 51. The unit holder 51 is provided with a pair of guided grooves 511, 511 to be slidably engaged with the pair of guide rails 423, 423 provided on the mount part 422, and is supported so as to be movable in the direction of arrow Z, through the engagement of its guided grooves 511, 511 with the guide rails 423, 423.

The laser beam irradiation means 52 shown radiates a pulsed laser beam from a condenser 522 mounted to the tip of a hollow cylindrical casing 521 disposed substantially horizontally. Incidentally, the laser beam irradiation means 52 will be described in detail later. In addition, an image pickup means 6 for detecting a machining region served to laser beam machining by the laser beam irradiation means 52 is disposed at a front end part of the casing 521 constituting the laser beam irradiation means 52. The image pickup means 6 includes an illuminating means for illuminating the work, an optical system for catching the region illuminated by the illuminating means, an image pickup device (CCD) for picking up the image caught by the optical system, and the like, and sends a picture signal corresponding to the picked-up image to the control means (described later).

The laser beam irradiation unit 5, in the embodiment shown, has a moving means 53 for moving the unit holder 51 in the direction of arrow Z along the pair of guide rails 423, 423. The moving means 53 includes a male screw rod (not shown) disposed between the pair of guide rails 423, 423, and a drive source such as a pulse motor 532 for rotationally driving the male screw rod. With the male screw rod (not shown) driven by the pulse motor 532 to rotate normally and reversely, the unit holder 51 and the laser beam irradiation means 52 are moved in the direction of arrow Z along the guide rails 423, 423. Incidentally, in the embodiment shown, the laser beam irradiation means 52 is moved upward when the pulse motor 532 is driven to rotate normally, and the laser beam irradiation means 52 is moved downward when the pulse motor 532 is driven to rotate reversely.

Returning to FIG. 1, the laser beam machining system shown in the figure has a cassette mount part 8a on which to mount a cassette for containing wafers as works. On the cassette mount part 8a, a cassette table 8 is disposed which can be moved vertically by a lift means (not shown). The cassette 9 is mounted on the cassette table 8. The wafers contained in the cassette 9 are each a semiconductor wafer 10 in the embodiment shown. The semiconductor wafer 10 is provided on its face side 10a with a plurality of devices 101 arranged in a matrix pattern. The devices 101 are demarcated from each other by streets 102 formed in a lattice pattern. The semiconductor wafer 10 has its back side adhered to a protective tape 12 mounted to an annular frame 11, with its face side 10a (the machining side) on the upper side (frame supporting step). Incidentally, when the semiconductor wafer 10 is to be machined from the back side thereof, the face side 10a of the semiconductor wafer 10 is adhered to the protective tape 12. Thus, the semiconductor wafer 10 is contained in the cassette 9 in the state of being supported on the annular frame 11 through the protective tape 12.

A temporary placing region 13a is set on the system housing 1, and a temporary placing table 13 for temporarily placing the work and aligning the semiconductor wafer 10 supported on the annular frame 11 through the protective tape 12 is disposed in the temporary placing region 13a. The laser beam machining system, in the embodiment shown, includes: a delivering means 14 for delivering the semiconductor wafer 10 supported through the protective tape 12 on the annular frame 11 contained in the cassette 9 mounted on the cassette mount table 8 (hereinafter referred to as the semiconductor wafer 10) onto the temporary placing table 13; a feeding means 15 for feeding the semiconductor wafer 10, thus delivered onto the temporary placing table 13, onto the chuck table 36; a cleaning means 16 for cleaning the semiconductor wafer 10 having undergone laser beam machining on the chuck table 36; and a cleaning feeding means 17 for feeding the semiconductor wafer 10, which has undergone laser beam machining on the chuck table 36, to the cleaning means 16. Further, the laser beam machining system in the embodiment shown has a display means 18 on which the picture picked up by the image pickup means 6 and the like are displayed.

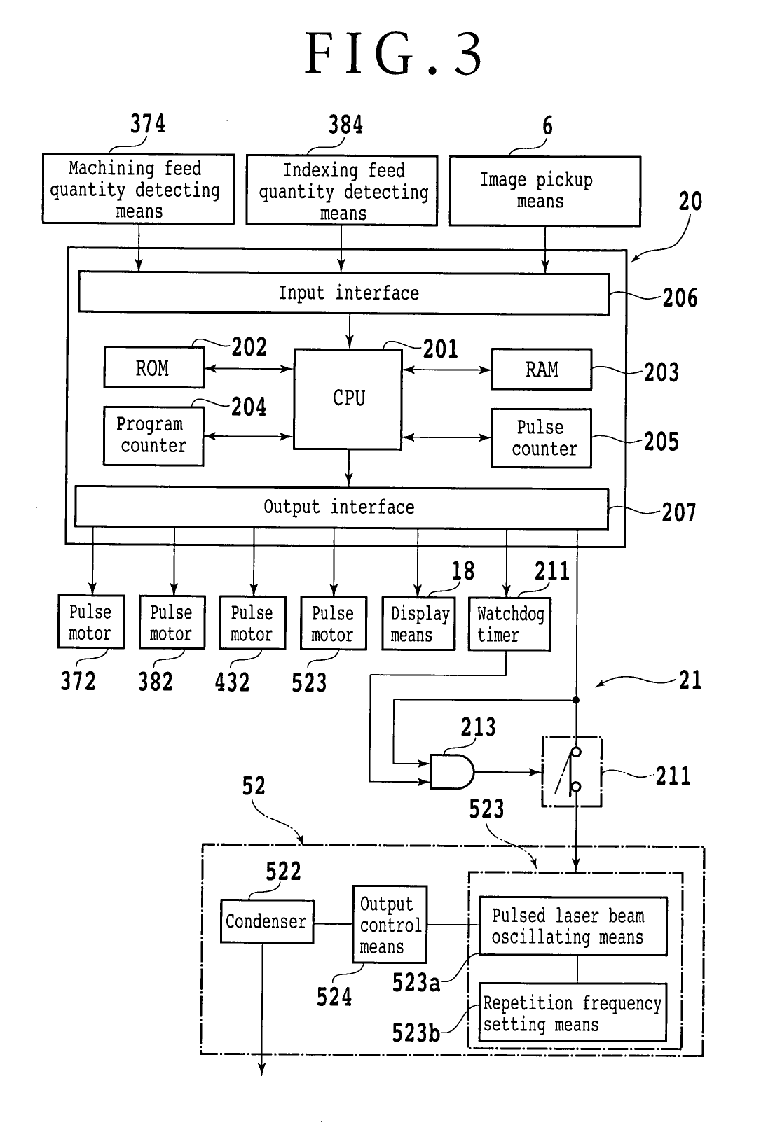

Now, the laser beam irradiation means 52 and the control means for controlling the operating means such as the laser beam irradiation means 52 will be described below, referring to FIG. 3. The laser beam irradiation means 52 shown in FIG. 3 includes a pulsed laser beam oscillating means 523 and an output control means 524 which are disposed in the casing 521, and the condenser 522 mounted to the tip of the casing 521. The pulsed laser beam oscillating means 523 is composed of a pulsed laser beam oscillator 523a composed of a YAG laser oscillator or a YVO4 laser oscillator, and a repetition frequency setting means 523b annexed thereto. The output control means 524 controls the output of a pulsed laser beam oscillated from the pulsed laser beam oscillating means 523 to a predetermined value. The laser beam irradiation means 52 thus configured is controlled by a control signal (gate signal) from the control means 20.

The control means 20 shown in FIG. 3 is composed of a computer, and includes: a central processor unit (CPU) 201 for executing arithmetic processes according to a control program; a read-only memory (ROM) 202 for storing the control program and the like; a random access memory (RAM) 203 which permits reading and writing of data therein and in which the results of calculations by the central processor unit (CPU) 201 and the like are stored; a program counter 204; a pulse counter 205 for counting the pulse signals sent from the reading head 374b of the machining feed quantity detecting means 374, the reading head 384b of the indexing feed quantity detecting means 384, and the like; and an input interface 206 and an output interface 207. The read-only memory (ROM) 202 stores therein a plurality of control programs, such as a machining program for controlling the laser beam irradiation means 52, a program for controlling the feeding-in and feeding-out of the semiconductor wafers 10 stored in the cassette 9, a cleaning program for controlling the cleaning means 16, etc. The plurality of control programs thus stored in the read-only memory (ROM) 202 are taken out on the basis of individual predetermined numbers of cycles under the action of the program counter 204. Detection signals from the machining feed quantity detecting means 374, the indexing feed quantity detecting means 284, and the image pickup means 6 are inputted to the input interface 206 of the control means 20 configured as above. In addition, control signals are outputted from the output interface 207 of the control means 20 to the pulse motor 372, the pulse motor 382, the pulse motor 432, the pulse motor 532, the laser beam irradiation means 52, the display means 18, and the like.

Referring to FIG. 3, the laser beam machining system in the embodiment shown has a safety means 21 for interrupting the gate signal, which is outputted from the control means 20 to the laser beam irradiation means 52, when an abnormal condition is generated in execution of the control programs in the control means 20. The safety means 21 includes an interrupter 211 which is disposed in a circuit for outputting a gate signal from the control means 20 to the laser beam irradiation means 52 and which interrupts the gate signal when necessary, a watchdog timer 212 for detecting the abnormal condition in execution of the control programs, and an AND circuit 213 as an interrupting signal output means for outputting an interrupting signal to the interrupter 211 when an abnormal-condition signal outputted by the watchdog timer 212 and the gate signal are inputted. The safety means 21 thus configured ensures that when an abnormal condition is generated in execution of the control programs under the condition where the gate signal is being outputted from the control means 20 to the laser beam irradiation means 52, the watchdog timer 212 detects the abnormal condition on the basis of an updating pulse outputted from the control program, and outputs an abnormal-condition signal to the AND circuit 213. On the other hand, a gate signal is inputted to the AND circuit 213 during when a gate signal is outputted from the control means 20 to the laser beam irradiation means 52; therefore, the AND circuit 213 outputs an interrupting signal to the interrupter 211 upon being supplied with the abnormal-condition signal from the watchdog timer 212. As a result, the interrupter 211 interrupts the circuit, as indicated by broken line in FIG. 3.

The laser beam machining system in the embodiment shown in the figures is configured as above, and the operation thereof will now be briefly described below, referring mainly to FIG. 1. The control means operates the lift means (not shown) of the cassette table 8 so as to position the semiconductor wafer 10 (supported on the annular frame 11 through the protective tape 12) contained at a predetermined position in the cassette 9 mounted on the cassette table 8, into a delivery position. Then, the control means 20 operates the delivering means 14 so as to deliver the semiconductor wafer 10, positioned in the delivery position, onto the temporary placing table 13. Next, the control means 20 operates the feeding means 15 so as to feed the semiconductor wafer 10, delivered onto the temporary placing table 13, onto the chuck table 36. When the semiconductor wafer 10 is mounted on the chuck table 36, the control means 20 operates the suction means (not shown) so as to hold the semiconductor wafer 10 onto the chuck table 36 by suction. In addition, the support frame 11 for supporting the semiconductor wafer 10 through the protective tape 12 is fixed by the above-mentioned clamps 362. When the semiconductor wafer 10 is held on the chuck table 36 in this manner, the control means 20 operates the machining feeding means 37 so as to move the chuck table 36, with the semiconductor wafer 10 held thereon by suction, to a position directly under the image pickup means 6. Next, the control means 20 operates the image pickup means 6 so as to pick up an image of the semiconductor wafer 10 held on the chuck table 36 by suction, and, based on the image pickup signal, an alignment operation for detecting the machining region in which to conduct laser beam machining of the semiconductor wafer 10 is carried out.

When the alignment operation for detecting the machining region in which to conduct the laser beam machining of the semiconductor wafer 10 held on the chuck table 36 as above, the control means 20 executes a laser beam machining step according to a predetermined machining program. Specifically, the control means 20 operates the machining feeding means 37 to move the chuck table 36 into the laser beam irradiation region where the condenser 522 is located, and the control means 20 operates the laser beam irradiation means 52 and the machining feeding means 37 so as to apply a predetermined laser beam machining to the semiconductor wafer 10 held on the chuck table 36.

When the laser beam machining has been carried out, the control means 20 operates the machining feeding means 37 so as to return the chuck table 36 with the semiconductor wafer 10 held thereon to the position where the semiconductor wafer 10 has initially been held by suction, and the holding of the semiconductor wafer 10 by suction is canceled in this position. Then, the control means 20 operates the cleaning feeding means 17 to feed the semiconductor wafer 10 on the chuck table 36 to the cleaning means 16. Next, the control means 20 operates the cleaning means 16 so as to clean the semiconductor wafer 10 having undergone the laser beam machining, and to dry the thus cleaned semiconductor wafer 10.

When the cleaning and drying operations have been applied to the machined semiconductor wafer 10 as above, the control means 20 operates the feeding means 15 so as to feed the cleaned semiconductor wafer 10 onto the temporary placing table 13. Subsequently, the control means 20 operates the delivering means 14 so as to store the semiconductor wafer 10, fed onto the temporary placing table 13, into a predetermined position in the cassette 19.

Upon the generation of an abnormal condition in the control programs under the condition where the laser beam machining is being carried out according to the machining program and the control means 20 is outputting the gate signal to the laser beam irradiation signal 52, the gate signal may be continuedly outputted to the laser beam irradiation means 52, with the result that irradiation with the laser beam radiated from the laser beam irradiation means 52 is continued, possibly causing a fire or the like. However, the laser beam machining system shown in the figure has the safety means 21 shown in FIG. 3, which ensures that when an abnormal condition is generated in execution of the control programs in the control means 20, the gate signal outputted from the control means 20 to the laser beam irradiation means 52 is interrupted. Specifically, when an abnormal condition is generated in execution of the control programs under the condition where the gate signal is being outputted from the control means 20 to the laser beam irradiation means 52, the watchdog timer 212 detects the abnormal condition and outputs an abnormal-condition signal to the AND circuit 213. On the other hand, the AND circuit 213 is supplied with the gate signal during when the gate signal is outputted from the control means 20 to the laser beam irradiation means 52. Therefore, the AND circuit 213 outputs an interrupting signal to the interrupter 211, upon being supplied with the abnormal-condition signal from the watchdog timer 212. As a result, the interrupter 211 interrupts the circuit as indicated by broken line in FIG. 3. Accordingly, the laser beam machining system in the embodiment shown ensures that even if an abnormal condition is generated in the control programs during when the gate signal is outputted from the control means 20 to the laser beam irradiation means 52, irradiation with the laser beam from the laser beam irradiation means 52 is prevented from being continued.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser beam machining system comprising:
a chuck table for holding a work;
laser beam irradiation means for irradiating said work held by said chuck table with a laser beam;
machining feeding means for relative machining feeding of said chuck table and said laser beam irradiation means;
control means for controlling said laser beam irradiation means and said machining feeding means according to a control program; and
safety means for interrupting a gate signal, which is outputted from said control means to said laser beam machining means, upon generation of an abnormal condition in execution of said control program in said control means.

2. The laser beam machining system as set forth in claim 1, wherein said safety means comprises: an interrupter which is disposed in a circuit for outputting said gate signal from said control means to said laser beam irradiation means and which interrupts said gate signal; a watchdog timer for detecting an abnormal condition in execution of said control program; and interrupting signal output means for outputting an interrupting signal to said interrupter upon receiving a gate signal and an abnormal-condition signal outputted from said watchdog timer.
